(19) United States
(12) Patent Application Publication
(10) Pub. No.: US 2015/0201460 A1
(43) Pub. Date: Jul. 16, 2015

(54) WIRELESS COMMUNICATIONS STATION WITH SATELLITE BACKHAUL

(71) Applicant: Michael Flynn, Rnacho Santa Fe, CA (US)

(72) Inventor: Michael Flynn, Rnacho Santa Fe, CA (US)

(21) Appl. No.: 14/153,087

(22) Filed: Jan. 13, 2014

(51) Int. Cl. H04W 88/10; H04B 1/69

(52) U.S. Cl. CPC H04W 88/10; H04B 1/69

(57) ABSTRACT

A wireless communications station is provided that includes base portion and a tower portion. The tower portion includes a plurality of solar panels, a Wi-Fi antenna, and satellite. The base portion includes a stabilizing ballast, communication backhaul portal, and a plurality of wireless transmission carriers, including a Wi-Fi carrier and a spectrum carrier. The communication backhaul portal is in communication with the wireless transmission carriers and the satellite. The communications station is mobile and operates independent from conventional landlines grids and without the need for traditional installation procedures. The solar panels provide a self-sufficient source of power. The communications station provides a Wi-Fi signal that allows an internet-enabled device to send and receive information over an internet protocol (IP) network where cellular service is unavailable, including the placement of enhance 911 calls.

### RELATED U.S. APPLICATION DATA

This application claims priority to Provisional Application No. 61/754,249 filed Jan. 18, 2013.

### FIELD OF THE INVENTION

The present invention relates to communications base stations, particularly wireless communications base stations.

### BACKGROUND OF THE INVENTION

Cellular communications systems and devices are widespread and serve as a primary means of communication. Cellular communications are supported within land areas called cells, each served by at least one fixed-location transceiver, known as a cell site or base station which provides coverage within a designated cell(s). When combined, these cell regions provide radio coverage over a large geographic area to enable a large number of portable devices to communicate with each other and with fixed transceivers within the network, via base stations. Major telecommunications providers have deployed voice and data cellular networks over most of the inhabited land area of the Earth, which allows mobile device such as phones computers to connected to the public switched telephone network and public Internet. However, there are often gaps in coverage between cells, and remote areas, including areas with problematic topology, where cellular coverage is unavailable or unreliable. Providing coverage in such areas is often cost-prohibitive because network usage is very minimal. Moreover, powering infrastructure is needed to connect the base stations to the grid, which requires additional hardware and labor expense.

In these non-coverage areas, users of cellular devices will be unable to place calls or transmit data. This lack of functionality is often critical in emergency situations where injured, stranded or lost individuals are seeking medical or other assistance. Thus, there is a need in the field for a low cost, easily-deployed base station that can facilitate emergency communications in remote areas where cellular coverage is non-existence or unreliable.

### SUMMARY OF THE INVENTION

A wireless communications station is provided that includes base portion and a tower portion. The tower portion includes a plurality of solar panels, a Wi-Fi antenna, and satellite. The base portion includes a stabilizing ballast, communication backhaul portal, and a plurality of wireless transmission carriers, including a Wi-Fi carrier and a spectrum carrier. The communication backhaul portal is in communication with the wireless transmission carriers and the satellite. The communications station is mobile and operates independent from conventional landlines grids and without the need for traditional installation procedures. The solar panels provide a self-sufficient source of power. The communications station provides a Wi-Fi signal that allows an internet-enabled device to send and receive information over an internet protocol (IP) network where cellular service is unavailable, including the placement of enhance 911 calls.

### BRIEF DESCRIPTION OF THE DRAWINGS

FIG. 1 illustrates the placement of an emergency call using VOIP facilitated by the remote wireless communication station.

FIG. 2 illustrates a side view of a multi-tiered modular solar tower base station with a plurality of interconnected wireless communication methods distributed throughout the structure.

FIGS. 3A-B illustrate front and back perspective views of a single-tiered modular solar tower base station with a double ballast tank system.

FIG. 4 illustrates a front perspective view of an extension-capable, modular solar tower base station with various alternative backup power elements housed within the ballast tank.

FIG. 5 illustrates a side view of a multi-tiered modular solar tower base station with emergency call box and various communications/power options.

FIG. 6 illustrates bottom and side views of dual ballast tank assembly via an adjoining bracket.

FIGS. 7A-B illustrate frontal views of a multi-tiered modular solar tower base station with three-tiered construction, in collapsed and extended positions.

### DETAILED DESCRIPTION

The present invention provides a modular, self-supporting communications site which consolidates numerous collection and distribution methods of various wireless bandwidths. The system may serve wireless communications needs both locally (within close proximity of a specific structure) and communally, as per wireless transmission needs—i.e. propagation. Its cost-effective nature lies in the streamlined, modular method of its construction—much smaller in size than current commercial wireless transmission base towers. This construction eliminates the need for civil site construction.

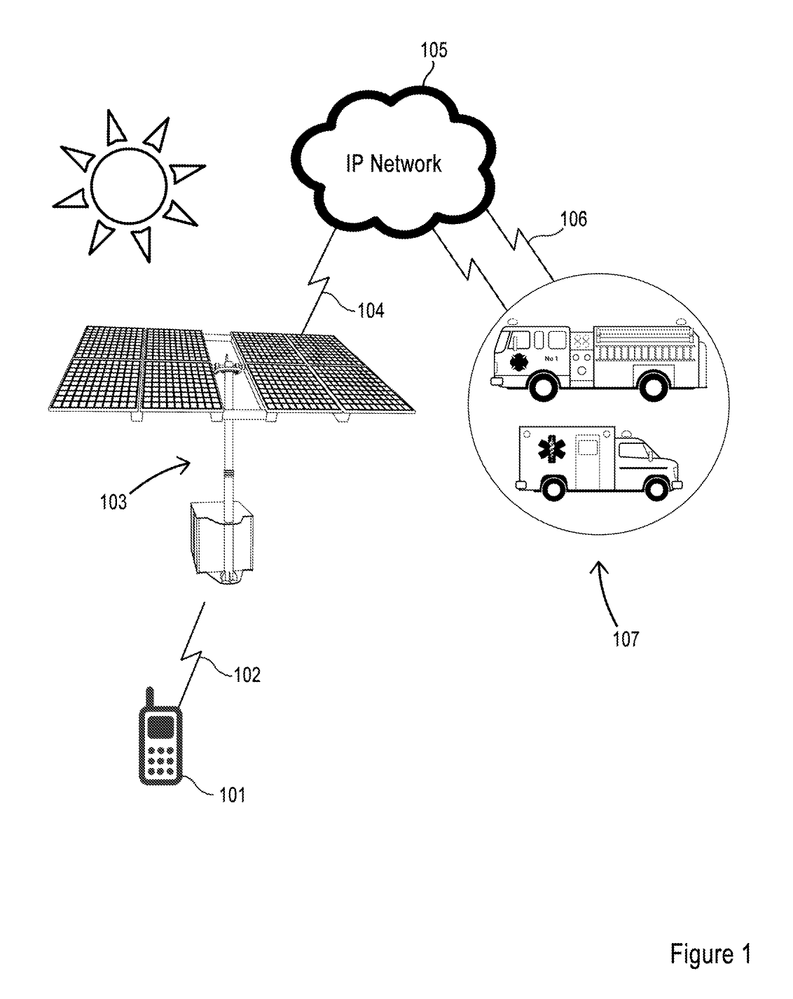

FIG. 1 illustrates a high level communication diagram showing how an emergency call is executed using the communication station 103 (also referred to as “solar tower base station”). A user in need of emergency services, for example, places a call to emergency services using their cell phone 102. If cellular service is not available, the communication station 103 provides Wi-Fi access 104 that allows for the call to be transmitted over an Internet protocol (IP) network 105 to facilitate a call 106 to emergency services 107. Alternatively, the IP network can be utilized for non-voice, data communications. The Wi-Fi access can be restricted as desired by the base station operator/carrier so that only authorized individuals, e.g. network subscribers, can utilize the Wi-Fi network to conduct internet communications. For example, if the cellular phone user (consumer) signs up for enhanced 911 (E911), then the consumer's cell phone will automatically make an E911 call if the cellular network is unavailable or congested.

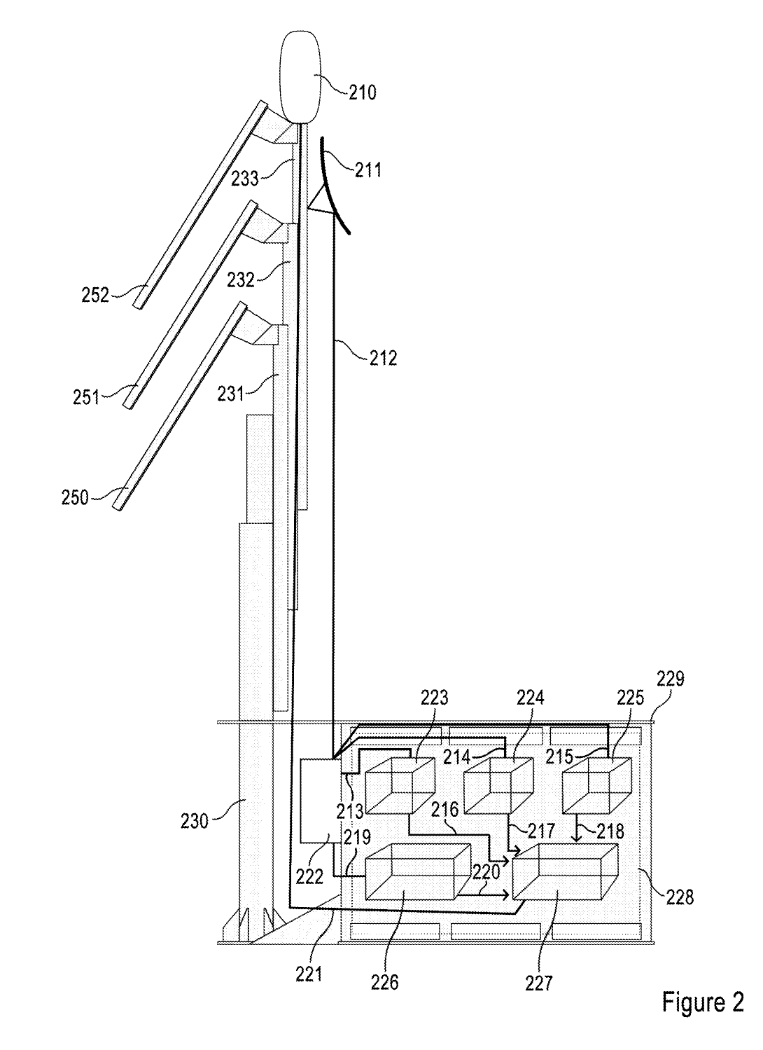

FIG. 2 illustrates the wireless communications base station of the present invention. The base station facility comprises a multi-tiered extendible core with solar panels 250-252, a base pole 230, and a ballast tank 229 attached to the base pole. Atop the highest tier sits a Wi-Fi antenna which facilitates a Wi-Fi access point for interne communications. Using IEEE 802.11b or 802.11g technology, the antenna may provide a Wi-Fi access range of 100 m (300 ft) outdoors or up to 600 ft using IEEE 802.11n technology. A short distance down the highest tier, there is an attached satellite 211. The satellite 211 provides backhaul of data to a core or backbone network. At the base of the communication station, the ballast tank serves as a counter weight for the extendible core, and further comprises a plurality of wireless transmission carriers, including a carrier A 223, carrier B 224, carrier C 225, spectrum carrier 227, and Wi-Fi carrier 226. Carriers A, B, and C transmit data to the spectrum carrier as visualized by connective arrows 216, 217, and 218 respectively. Connective arrow 220 represents the transmission of data from the WIFI carrier to the spectrum carrier. Attached on the exterior of the ballast tank 229, on the side facing the base pole 230, there lies a communications backhaul portal 222. This portal communicates with carriers A, B, and C via lines 213, 2.14, and 215 respectively. The backhaul portal communicates with the Wi-Fi carrier 226 via line 219. The satellite 211 transmits a signal to the portal via line 212, while the antenna 210 transmits a signal to the spectrum carrier 227 via line 221. In the capacity of a communications backhaul, the satellite serves as the direct link to the global core network, linking the packets it receives to the carriers housed with the ballast tank.

Thus, the wireless communication station is mobile and can be easily deployed in remote locations where cellular coverage is absent or unreliable, without the need for grid connections or external power. When a user's cell phone service determines that cellular coverage is unavailable, the antenna 210 provides a Wi-Fi signal that can be utilized by the cell phone to place a VOIP call, such as an E911 call. This communication over the IP network is facilitated by the backhaul provided by satellite 211.

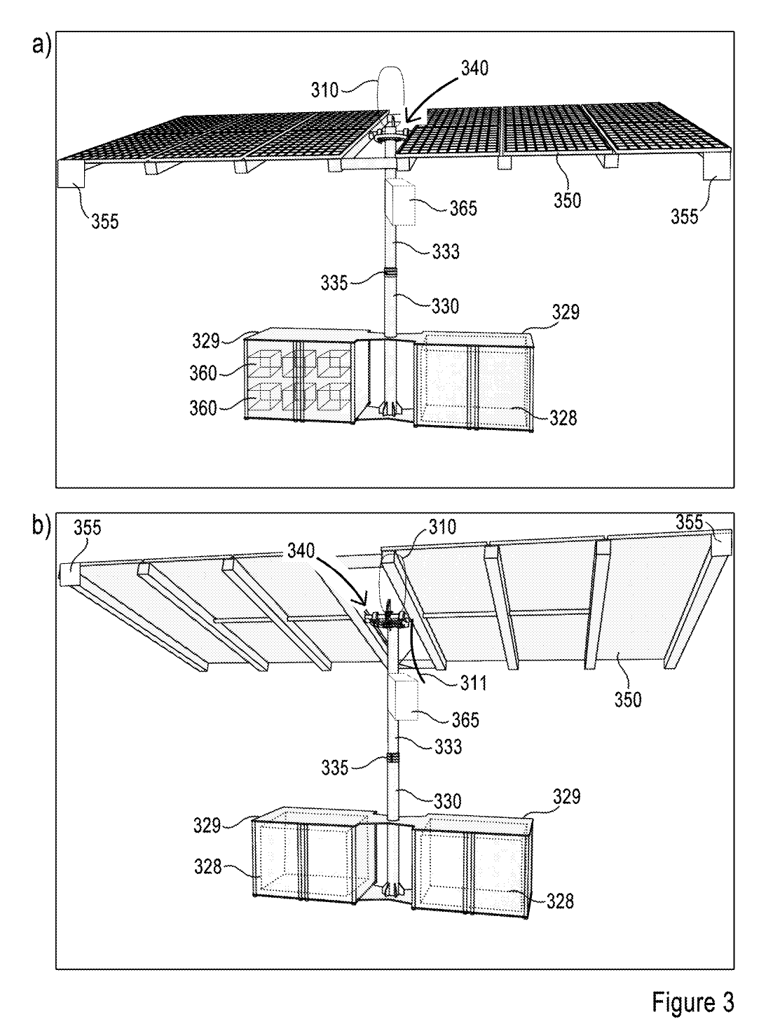

FIG. 3A-B illustrate front and back perspective views of a single-tiered modular solar tower base station with a double ballast tank system. In FIG. 3A, the base pole 330 houses an extendible pole 333 which is adjusted between collapsed and extended positions via adjustment mechanism 335. In this embodiment, two ballast tanks 329 are utilized to provide counter-weighting for the structure. They meet, and are attached at two points vertically along the base pole 330. Radio equipment 365 may be found on the extendible pole, as well as an antenna 310 at the very top of the tower head 340. The solar panels have been rotated in such a way that their solar cells would receive more direct sunlight if the sun were directly above the base station. This example of user-specified or automated alignment is aided by orientation hardware 355 located on the corner edges of the solar panels 350. As well, mechanically speaking, this orientation procedure is accomplished primarily by the tower head 340, which comprises a number of specially designed parts (e.g. pins, pin holes, ball bearings, etc.) that work in concert to rotate the solar panels horizontally and vertically. FIG. 3A shows an additional alternative power option with batteries 360 placed within the ballast tank 329. FIG. 3B shows a rear view of the same solar tower base station. Here, on the interiors of the ballast tanks 329, ballasts 328 may be placed for additional counter-weighting.

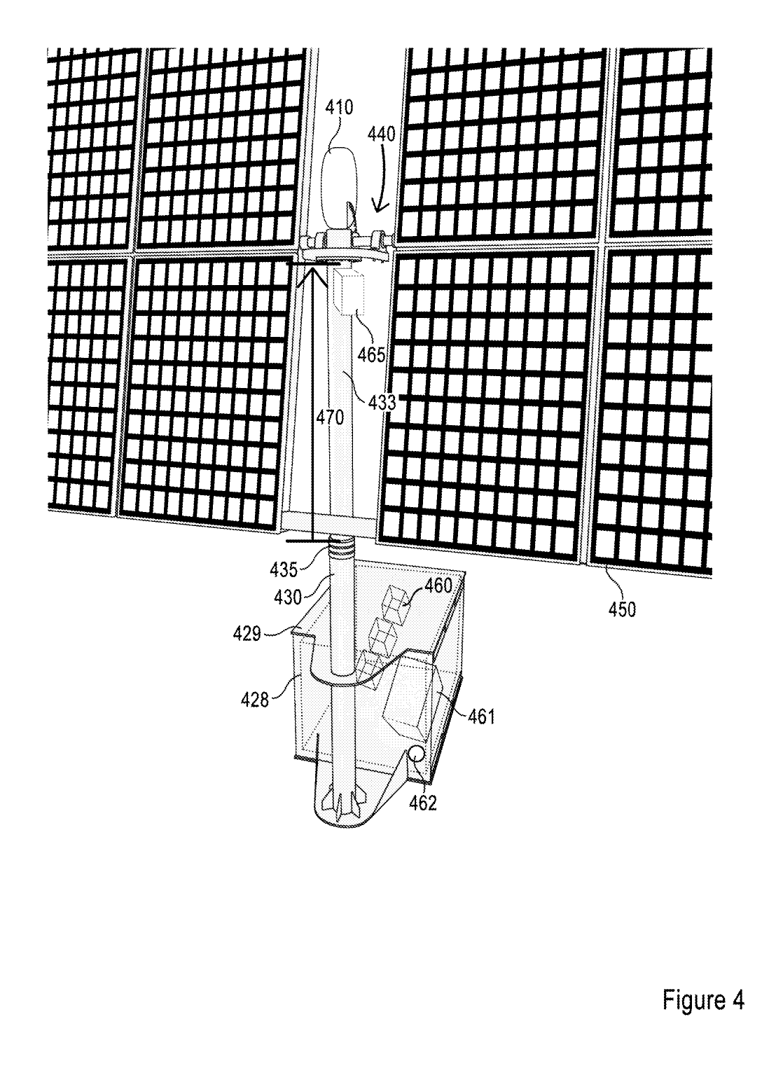

FIG. 4 illustrates a front perspective view of an extension-capable, modular solar tower base station with various alternative backup power elements housed within the ballast tank. The raising and lowering action of extendible pole 433 is denoted by arrow 470. Again, radio equipment 465 is placed on the extendible pole. In this instance, the ballast tank 429 houses a number of standard alternative backup power elements, including batteries 460, an optional generator with fuel 461, and an optional connection device for generator plug-in 462. On certain occasions, where weather or some other circumstance doesn't permit the proper capturing of sunlight, chemical energy may instead be derived from said alternatives in the ballast tank.

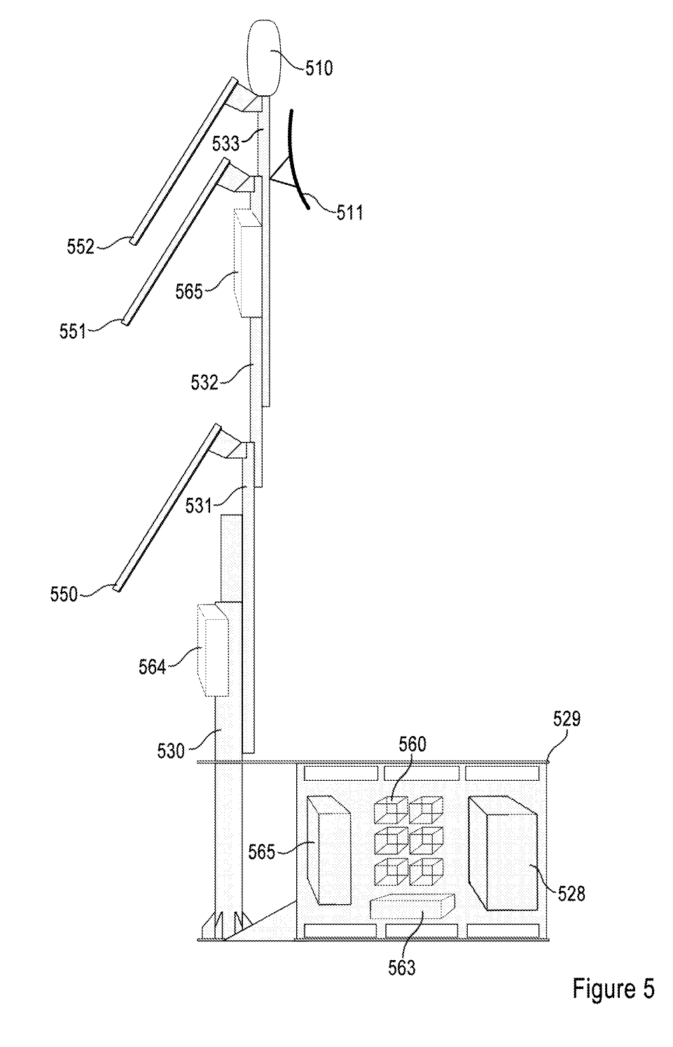

FIG. 5 illustrates a side view of a multi-tiered modular solar tower base station with emergency call box and various communications/power options. As with previous figures, radio equipment 565 can be found on one of the extendible tiers, with a satellite 511 and an antenna 510 near the top. In this instance however, radio equipment 565 is also shown within the ballast tank 529. Additionally, power options such as batteries 560 and a power supply 563 are also housed within the tank. Also unique to this version of the ballast tank is the ballast 528 itself, which joins both the radio equipment and backup power supplies in the ballast tank.

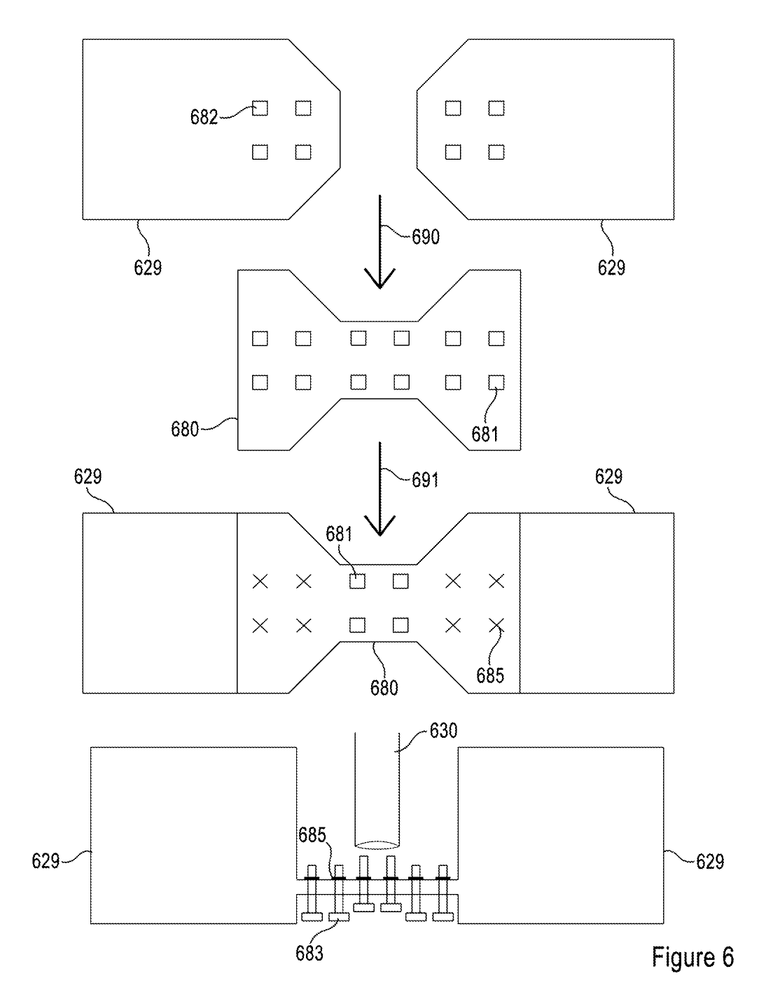

FIG. 6 illustrates bottom and side views of dual ballast tank assembly via an adjoining bracket. The ballast tanks 629 (or ballast bottom for purposes of explaining construction procedures within this figure) possess bolt openings 689; they are to be joined via the adjoining bracket 680, which possesses its own bracket bolt openings 681. Arrow 690 indicates the placing of adjoining bracket 680 between the ballast tanks, lining up the appropriate bolt openings for each piece. With two ballast tanks 629 in place, an appropriate distance apart, the base station can be stabilized. The case of construction for such a modular facility is clearly shown by this procedure. Arrow 691 indicates the transition to a complete joining of bracket and tanks, where “x's” 685 show the points at which the ballast tank bolt openings 682 and the adjoining bracket bolt openings 681 line up, in such a way that the tanks are flush, and allow the pass-through of bolts. The bottom image of the tanks (side view) shows a complete double ballast tank setup, with the exception of base pole 630 addition. The connective bolts 683 have been placed through the lined up “x's” 685. All that remains is to attach the base pole 630 to the bolts in the center.

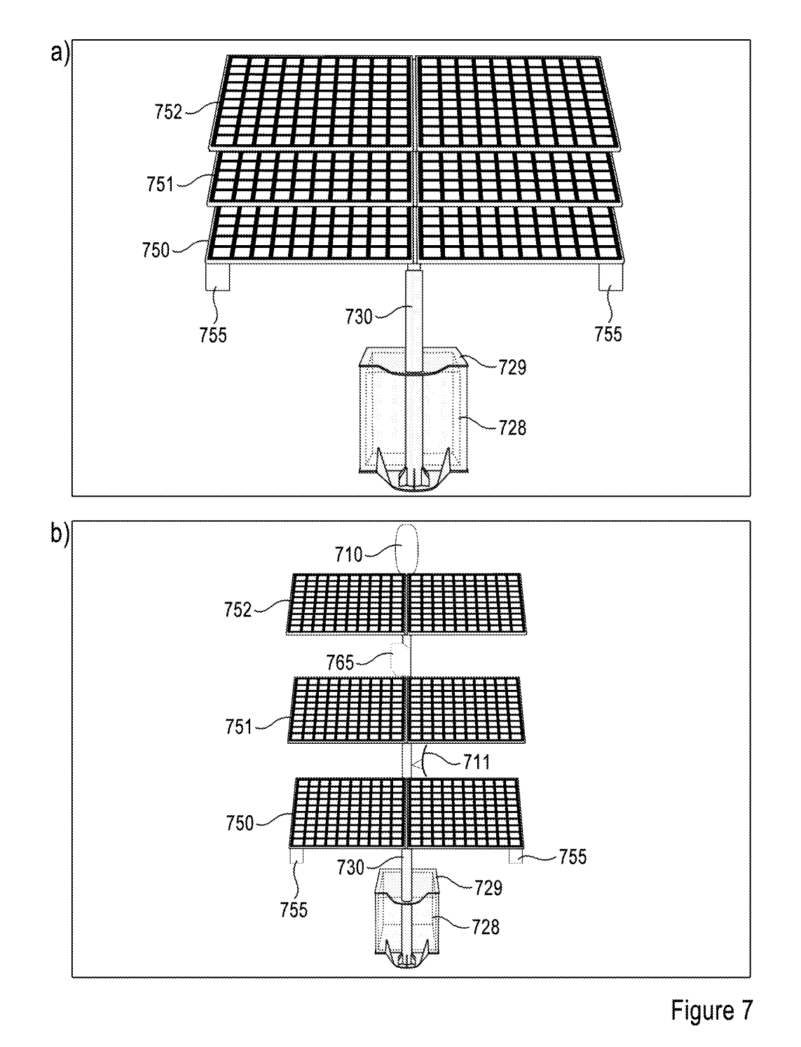

FIG. 7A-B illustrate frontal views of a multi-tiered modular solar tower base station with three-tiered construction, in collapsed and extended positions. In FIG. 7A, the solar panels have been lowered via their collapsible poles; the hollow poles lie within the interior of the base pole 730. In this scenario, the base station becomes a more compact structure that doesn't necessarily need to utilize as much sunlight, or has been temporarily adjusted into a chemical energy derivation mode—its panels temporarily out of operation. The plethora of configuration options for the base station ensure continued operation through any disasters or other complications, allowing it to operate off the grid in almost any emergency situation.

FIG. 8B shows the base station panels to be fully extended; its poles raised and locked into place to allow for full absorption of sunlight via the solar panels. As with previous figures, orientation hardware 855 can now be utilized to further rotate the solar panels 850-652 and achieve ideal absorption of sunlight. The orientation hardware works in conjunction with a database of year-round sun position data. With a multitude of physical orientation options available, the solar tower facility would be the ideal constituent of an array of base stations set to receive and disseminate wireless data around the world, especially in remote areas which are chronically devoid of larger commercial towers set up by established leaders in the telecommunications industry.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A communications base station comprising:
a base portion that stabilizes the base station, the base portion comprising a ballast housing and at least one ballast, the base portion further comprising a plurality of wireless transmission carriers;
a tower column;
a Wi-Fi antenna mounted to the tower column, the antenna providing a Wi-Fi access point for internet comminations;
a satellite mounted to the tower column which provides communications backhaul;
a backhaul portal in communication with the wireless transmission carriers and the satellite; and
a pair of solar panels connected with the tower column via a solar panel mounting structure.

2. The communications base station of claim 1 wherein the wireless transmission carriers include a Wi-Fi carrier and a spectrum carrier.
